(19) United States
(12) Patent Application Publication
(10) Pub. No.: US 2022/0108494 A1
(43) Pub. Date: Apr. 7, 2022

(54) METHOD, DEVICE, AND STORAGE MEDIUM FOR POINT CLOUD PROCESSING AND DECODING

(71) Applicant: SZ DJI TECHNOLOGY CO., LTD., Shenzhen (CN)

(72) Inventors: Pu LI, Shenzhen (CA); Xiaozhen ZHENG, Shenzhen (CN)

(21) Appl. No.: 17/644,178

(22) Filed: Dec. 14, 2021

Related U.S. Application Data
(63) Continuation of application No. PCT/CN2019/126090, filed on Dec. 17, 2019.

(30) Foreign Application Priority Data
Jun. 14, 2019 (CN) PCT/CN2019/091351
Dec. 6, 2019 (CN) PCT/CN2019/123821

(51) Int. Cl. G06T 9/40; G06T 17/00

(52) U.S. Cl. CPC G06T 9/40; G06T 17/00

(57) ABSTRACT

A processing method includes encoding or decoding an N-th layer of a multi-tree using a breadth-first mode. The multi-tree is used for position division on a point cloud. The method further includes, in response to a number or a distribution of all point cloud points in a target node of the N-th layer meeting a preset condition, encoding or decoding the point cloud points in the target node using a depth-first mode to obtain a code stream of the target node. The code stream of the target node includes an identifier and indexes of nodes where the point cloud points of the target node are located at various layers of the multi-tree. The identifier indicates to switch from the breadth-first mode to the depth-first mode to encode or decode sub-nodes of the target node. N is an integer greater than or equal to 1.

### CROSS-REFERENCE TO RELATED APPLICATIONS

This application is a continuation of International Application No. PCT/CN2019/126090, filed Dec. 17, 2019, which claims priority to International Application No. PCT/CN2019/091351, filed. Jun. 14, 2019, and International Application No. PCT/CN2019/123821, field Dec. 6, 2019, the entire contents of all of which are incorporated herein by reference.

### TECHNICAL FIELD

The present disclosure relates to the field of data encoding/decoding and, more particularly, to a method, a device, and a storage medium for point cloud processing and decoding.

### BACKGROUND

A point cloud is a form of expression of a three-dimensional object or a three-dimensional scene, and includes a set of discrete points that are randomly distributed in space. The set of discrete points expresses the spatial structure and surface properties of the three-dimensional object or the three-dimensional scene. Data of a point cloud may include three-dimensional coordinates describing coordinate information, and may further include attributes of the position coordinates. To accurately reflect the information in the space, the number of discrete points required is huge. To reduce the storage space and the bandwidth occupied during transmission of a point cloud, the point cloud needs to be encoded and compressed.

In existing technologies, a breadth-first layer-by-layer multi-tree division encoding method is often used to encode and compress a point cloud. However, the point cloud encoding in this way has higher complexity and lower parallelism. Therefore, how to improve the encoding or decoding performance of the point cloud is a problem to be solved.

### SUMMARY

In accordance with the disclosure, there is provided a processing method including encoding or decoding an N-th layer of a multi-tree using a breadth-first mode. The multi-tree is used for position division on a point cloud. The method further includes, in response to a number or a distribution of all point cloud points in a target node of the N-th layer meeting a preset condition, encoding or decoding the point cloud points in the target node using a depth-first mode to obtain a code stream of the target node. The code stream of the target node includes an identifier and indexes of nodes where the point cloud points of the target node are located at various layers of the multi-tree. The identifier indicates to switch from the breadth-first mode to the depth-first mode to encode or decode sub-nodes of the target node. N is an integer greater than or equal to 1.

Also in accordance with the disclosure, there is provided a decoding method including decoding an N-th layer of a multi-tree using a breadth-first mode. The multi-tree is used for position division on a point cloud. The method further includes, in response to parsing to an indentifier, decoding a code stream of a target node of the N-th layer using a depth-first mode. The code stream of the target node includes an identifier and indexes of nodes where the point cloud points of the target node are located at various layers of the multi-tree. The identifier indicates to switch from the breadth-first mode to the depth-first mode to encode or decode sub-nodes of the target node. N is an integer greater than or equal to 1.

Also in accordance with the disclosure, there is provided a processing device for a point cloud including a memory and a processor. The memory stores a program. The processor is configured to execute the program stored in the memory to encode or decode an N-th layer of a multi-tree using a breadth-first mode. The multi-tree is used for position division on the point cloud. The processor is further configured to execute the program to, in response to a number or a distribution of all point cloud points in a target node of the N-th layer meeting a preset condition, encode or decode the point cloud points in the target node using a depth-first mode to obtain a code stream of the target node. The code stream of the target node includes an identifier and indexes of nodes where the point cloud points of the target node are located at various layers of the multi-tree. The identifier indicates to switch from the breadth-first mode to the depth-first mode to encode or decode sub-nodes of the target node. N is an integer greater than or equal to 1.

### BRIEF DESCRIPTION OF THE DRAWINGS

FIG. 1 is a schematic flow chart of an encoding process of point cloud compressing.

FIG. 2 is a schematic flow chart of a decoding process of point cloud compressing.

FIG. 3 is a schematic diagram of a cubic octree division consistent with the present disclosure.

FIG. 4 is a schematic diagram of a layer-by-layer division of octree nodes consistent with the present disclosure.

FIG. 5 is a schematic flow chart of an attribute encoding process consistent with the present disclosure.

FIG. 6 is a schematic flow chart of another attribute encoding process consistent with the present disclosure.

FIG. 7 is a schematic structural diagram of hierarchical encoding consistent with the present disclosure.

FIG. 8 is a schematic flow chart of binary encoding with a coaxial optical path consistent with the present disclosure.

FIG. 9 is a schematic flow chart of binary decoding consistent with the present disclosure.

FIG. 10 is a schematic flow chart of a method for point cloud processing consistent with the present disclosure.

FIG. 11 is a schematic flow chart of a point cloud encoding process consistent with the present disclosure.

FIG. 12 is a schematic flow chart of another point cloud encoding process consistent with the present disclosure.

FIG. 13 is a schematic block diagram of a point cloud processing device consistent with the present disclosure.

FIG. 14 is a schematic block diagram of a point cloud decoding device consistent with the present disclosure.

### DETAILED DESCRIPTION OF THE EMBODIMENTS

The technical solutions in the embodiments of the present disclosure will be described below in conjunction with the drawings in the embodiments of the present disclosure. Obviously, the described embodiments are some of the embodiments of the present disclosure, but not all of the embodiments. Based on the embodiments in this disclosure, all other embodiments obtained by those of ordinary skill in the art without creative work shall fall within the scope of this disclosure.

Unless otherwise specified, all technical and scientific terms used in the embodiments of the present disclosure have the same meaning as commonly understood by those skilled in the technical field of the present disclosure. The terms used in this disclosure are only for the purpose of describing specific embodiments, and are not intended to limit the scope of the present disclosure.

In existing technologies, a point cloud encoding process has problems of high complexity, high cost, and low parallelism. The present disclosure provides a point cloud processing method to at least partially alleviate the above problems. Before describing various embodiments of the present disclosure, the point cloud encoding process in the existing technologies will be described first.

A point cloud is a form of expression of a three-dimensional object or a three-dimensional scene, and includes a set of discrete points that are randomly distributed in space. The set of discrete points expresses the spatial structure and surface properties of the three-dimensional object or the three-dimensional scene. To accurately reflect the information in the space, the number of the discrete points required is huge. To reduce the storage space and the bandwidth occupied during transmission of a point cloud, the point cloud needs to be encoded and compressed. The point cloud includes discrete points and data of each point may include position information describing position coordinates of the point, and may further include attribute information. The position coordinates may be three-dimensional position coordinates (x, y, z), and the attribute information may include reflectivity and/or color of the point cloud.

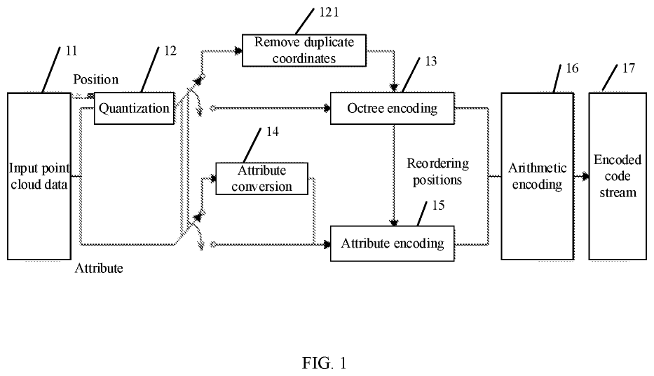

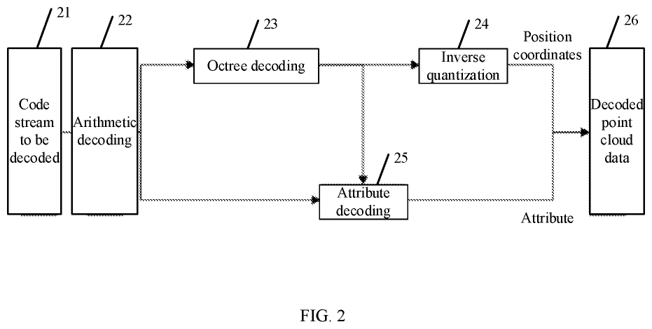

To accurately reflect the information in the space, the number of the required points in the point cloud is usually huge. To reduce the storage space and the bandwidth occupied during transmission of the point cloud, the point cloud needs to be encoded and compressed. A point cloud encoding and decoding process will be described with reference to FIG. 1 and FIG. 2.

FIG. 1 is a schematic flow chart of an encoding process of point cloud compressing. As shown in FIG. 1, by inputting point cloud data in 11, position coordinates of the input point cloud data are quantized in 12. For example, according to difference between maximum values and minimum values of the position coordinates in the three axes, and a quantization accuracy determined according to input parameters, the position coordinates of each point in the point cloud are quantized and the position coordinates of the input point cloud are converted into integer coordinates greater than or equal to zero. Then duplicated coordinates in the position coordinates are removed in 121, and position encoding 13 is performed on the processed position coordinates, for example, using octree encoding. And then attribute conversion 14 is performed on attributes of the input point cloud data, and attribute encoding 15 is performed on the attributes corresponding to the reordered position order after position encoding. Arithmetic encoding 16 is performed on the encoded binary code stream, to obtain code stream data 17 after encoding the point cloud data. In some examples, the code stream data is output to a memory for storage, or transmitted to a decoding end.

FIG. 2 is a schematic flow chart of a decoding process of point cloud compressing. As shown in FIG. 2, by obtaining code stream data to be decoded in 21, arithmetic decoding 22 is performed on the code stream data to be decoded. The arithmetic decoded data is inversely quantized in 24 by the octree encoding 23, and the position coordinates of the point cloud data are obtained. Attribute decoding 25 is performed on the data after the arithmetic decoding to obtain the attributes of the point cloud data, and finally the decoded point cloud data 26 is obtained according to the attributes and position coordinates of the point cloud data.

It should be understood that the point cloud data mentioned above includes attribute information, but it should be understood that, in some examples, the point cloud data may not include attribute information, and only include position coordinate information.

In one example, in an encoding end, after initializing a space of the point cloud to obtain an initialization space, when the initialization space is divided in the multi-tree, the division of each layer of the multi-tree may use coordinates of a center point of a current node to perform division on sub-nodes, to divide the current node into a plurality of sub-nodes through the center point. And then it may be determined whether there are points in each sub-node of the plurality of sub-nodes, and sub-nodes of the plurality of sub-nodes containing the points will be further divided until the sub-nodes are divided into a preset size, for example, into sub-nodes with a side length of 1 to stop the division. The initialization space may be a cube, a cuboid, or a space body of another shape.

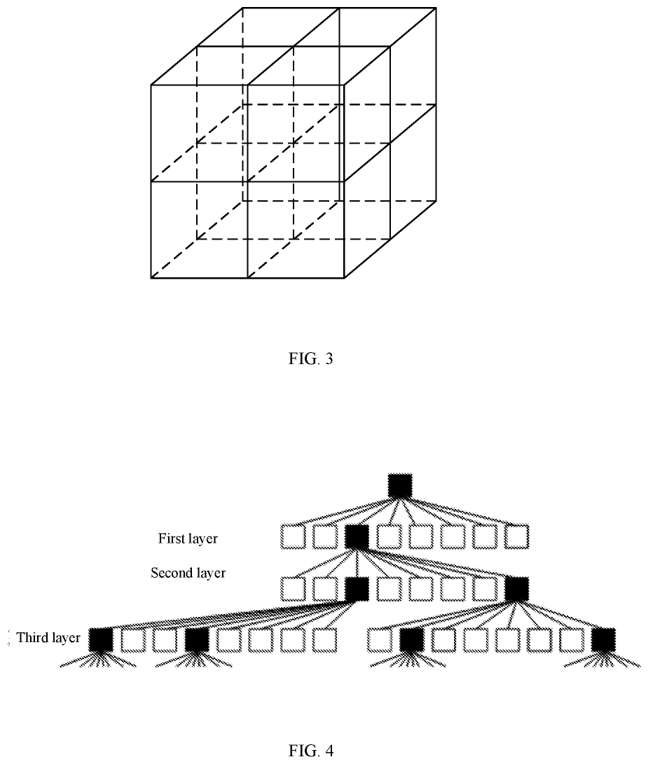

For example, taking the octree division as an example, the division of each layer of the octree uses the coordinates of the center point of the current block for sub-block division, and the current block is divided into eight small sub-blocks through the center point. A schematic diagram of performing the octree division for one encoding block is shown in FIG. 3 which is a schematic diagram of a cubic octree division, that is, a division method in which a node is divided into 8 sub-nodes. After the sub-block division, it will be determined whether there are points in each sub-block, and the sub-blocks containing points will be divided until the sub-block is divided to the minimum, that is, the sub-blocks with a side length of 1. The schematic diagram of the recursive division of the octree is shown in FIG. 4, which is a schematic diagram of the layer-by-layer division of octree nodes.

In one example, after the octree encoding is performed on the position coordinates, the attributes are compressed and encoded according to the attributes corresponding to the order of the position coordinates after the octree encoding. The attribute encoding may adopt hierarchical encoding or binary encoding method for encoding.

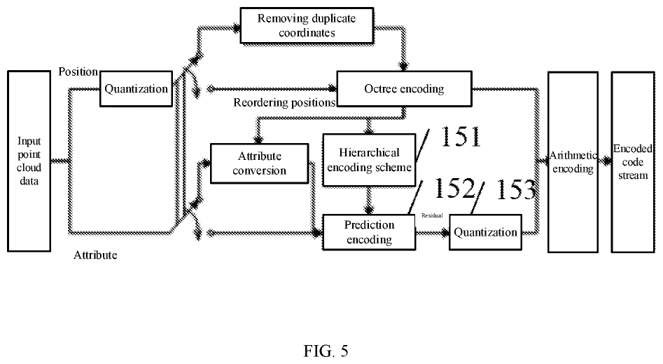

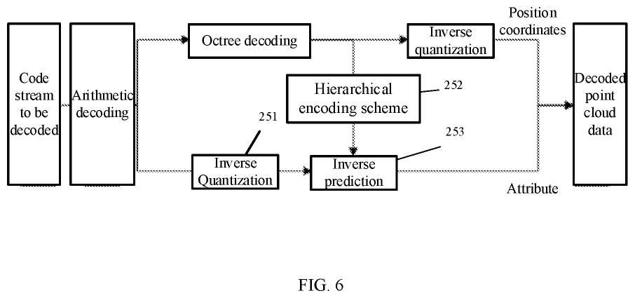

For example, as shown in FIG. 5 and FIG. 6, the attribute encoding may be hierarchical encoding. FIG. 5 is a schematic flow chart of an attribute encoding process. FIG. 6 is a schematic flow chart of another attribute encoding process. Description of the symbols in FIG. 5 and FIG. 6 that are the same as those in FIG. 1 and FIG. 2 is not repeated here.

In an example shown in FIG. 5, the attribute encoding process includes 151, 152, and 153. In 151, a layer of detail (LOD) encoding scheme is generated based on the encoded position coordinates. In 152, predictive encoding is performed based on the layer of the detail encoding scheme. In 153, the result of predictive encoding is quantized.

In another example shown in FIG. 6, the attribute decoding process includes 251, 252, and 253. In 251, the decoded attribute code stream is inversely quantized. In 252, based on the decoded position coordinates of the position coordinates, a hierarchical decoding scheme is generated. In 253, predictive decoding is performed based on the hierarchical decoding scheme.

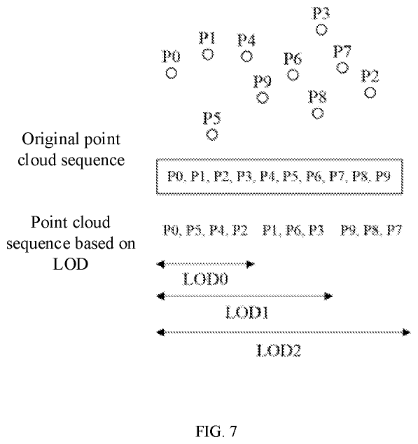

In one example, in the actual encoding process, LOD layering is performed according to the parameters of the LOD configuration. Latter layers contain the points of previous layers. For example, as shown in FIG. 7 which is a structural diagram of a hierarchical encoding process, the points contained in LOD0 (layer 0) are P0, P5, P4, P2; the points contained in LOD1 (layer 1) are P0, P5, P4, P2, P1, P6, P3; and the points contained in LOD2 (layer 2) are P0, P5, P4, P2, P1, P6, P3, P9, P8, P7.

In one example, in the layering process, a first point cloud in the point cloud data is selected and placed on the first point of the LOD0 layer. And then the point cloud is traversed in turn, to calculate distances from this point to all current points contained in the current layer in the Cartesian coordinate system. If the minimum distance of the calculated distances is greater than a distance threshold (dist2) set in the current LOD layer, the point will be divided into the current LOD layer. Also, in this process, the calculated distances are sorted, and the smallest ones are selected. This number of the smallest ones is determined by the number of neighbors in prediction. After a point cloud is divided into a LOD layer, there is no need to judge whether it still belongs to the next LOD layer, because the next layer contains the previous layer and the first few points of the LOD0 layer, and it must belong to the next LOD layer. The number of selected reference points may be less than the number N because the number of points in the LOD is relatively small.

In one example, after the division of the LOD layers ends, the nearest point previously selected may be used to assign weights for prediction. Specifically, for each point cloud point, after the nearest X points sorted by distance have been obtained, the weights can be calculated according to 1 reference point, 2 reference points and up to X reference points respectively. There are X kinds of weight distribution schemes. When there is 1 reference point, the point with the smallest distance is used as the reference point, and its weight is 1. When there are 2 reference points, the 2 points with the smallest distance are selected as the reference point and the weight will be assigned according to the distance between the two reference points and the point to be predicted. Specifically, the weight is inversely proportional to the distance. The longer the distance, the smaller the weight, and the weighted sum is guaranteed to be 1. When there are X reference points, it is to select X reference points, and the weight distribution method is the same as before.

In one example, after the weights are assigned, the number of reference points can be selected. It should be noted here that the number of adjacent reference points that can be selected for a prediction point is less than or equal to X. Specifically, when the maximum number of reference points is limited to 1, a sum of values obtained by quantizing residual values of the predicted value (weight multiplied by the attribute value of the corresponding position) and the actual attribute value, is traversed, and the sum is used as a cost when the maximum number of reference points is 1. Then it will traverse the cost when the maximum number of reference points is limited to 2 until the cost when the maximum number of reference points is limited to X is traversed, and finally, a scheme with the smallest cost and the maximum number of reference points is elected. Further the quantized residual value under this scheme is encoded.

In one example, the header information about the attributes in the encoded code stream can describe the relevant information about the hierarchical encoding attributes, that is, the LOD. The header information may specifically include the selection of adjacent reference points (used to calculate residuals) when predicting at each layer. The number of points (numberOfNeighborsInPrediction), the number of LOD layers (layerOfDetailCount), the distance threshold (dist2) by which each layer of LOD is divided, the quantization step of each layer of LOD (quantizationSteps), a size of a dead zone in each layer of LOD (quantizationDeadZoneSizes) (that is, the residual interval where the residual is quantized to 0). The last three attributes can be set for each layer of the LOD, and the attributes of each layer can be written into the code stream header information.

In one example, the encoding of the attributes may also adopt a binarization encoding manner, and the encoding manner of the binarization encoding may be a fixed-length encoding manner, a truncated Rice encoding manner, or a K-order exponential Columbus encoding manner. Correspondingly, the decoding mode of the binarization decoding can be a fixed-length decoding mode, a truncated Rice decoding mode, or a K-order exponential Columbus decoding mode

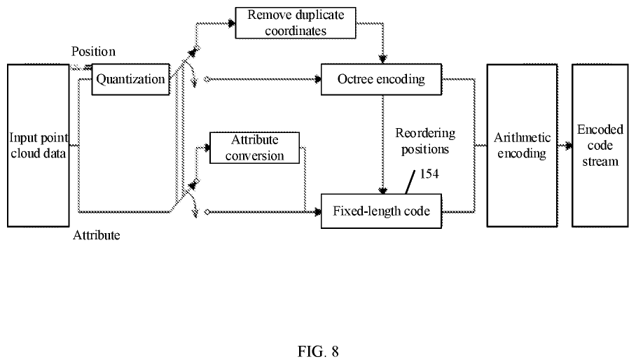

FIG. 8 will be used as an example to illustrate the fixed-length encoding mode in the binarization encoding mode. FIG. 8 is a schematic flowchart of a binarization encoding process, which includes binary encoding 154 performed by a fixed-length encoding method, and the symbols in FIG. 8 that are the same as those in FIG. 1 will not be repeated here.

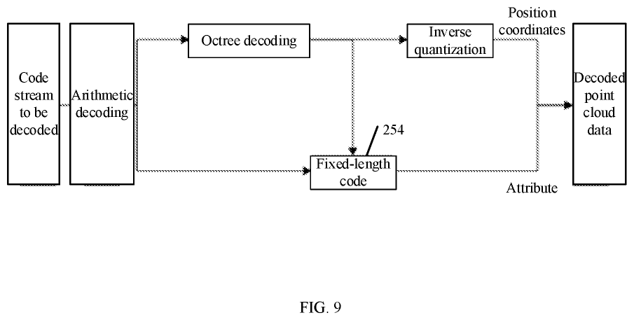

FIG. 9 is an example to illustrate the fixed-length encoding mode in the binarization decoding mode. FIG. 9 is a schematic flowchart of a binarization decoding process, which includes binary decoding 254 performed by a fixed-length encoding method, and the symbols in FIG. 8 that are the same as those in FIG. 2 will not be repeated here. Encoding using binary encoding can simplify the encoding method and reduce the time overhead of encoding and decoding, and there is no need to add more encoding information to the code stream, thereby improving the compression rate.

In the existing point cloud encoding method, the process of octree-division encoding for the position coordinates adopts the traversal of the octree based on the breadth-first order, and further iteration of the octree sub-blocks containing point cloud points. The process has high complexity, and there is a waste of encoded bits in the division representation of some sub-blocks containing only one leaf node. This affects the performance of the octree encoding on the compression rate to a certain extent. Further, the octree division process of the position coordinates is based on the breadth-first order to traverse the octree. This division process is carried out layer by layer. Only after one layer is divided can the next layer be divided. This process brings great difficulties to the parallelization of point cloud compression.

The present disclosure provides a solution to at least partially alleviate the above problems. In the present disclosure, an octree encoding or decoding method of the point cloud with a mixture of the breadth-first and depth-first mode may be adopted to encoding or decoding position coordinates, when performing compression encoding or decoding on the point cloud. When encoded or decoded to a certain node, if the number or distribution of all point cloud points in the node meets a preset condition, the encoding or decoding will be switched from the breadth-first mode to the depth-first mode. Through this implementation, overhead and complexity in the encoding process may be reduced, and the parallelism of point cloud encoding may be improved.

Methods for point cloud processing provided by various embodiments of the present disclosure may be applied to a point cloud processing device. The point cloud processing device may be a point cloud encoding device or a point cloud decoding device, and the point cloud encoding device can be set in a smart terminal (such as a mobile phone, a tablet, etc.). Methods for point cloud decoding proposed provided by various embodiments of the present disclosure may be applied to a point cloud decoding device, and the point cloud decoding device may also be set on a smart terminal (such as a mobile phone, a tablet, etc.). In some embodiments, the embodiments of the present disclosure can also be applied to an aircraft (such as an unmanned aerial vehicle). In other embodiments, the embodiments of the present disclosure can also be applied to other movable platforms (such as unmanned ships, unmanned automobiles, robots, etc.). The present disclosure has no limit on this.

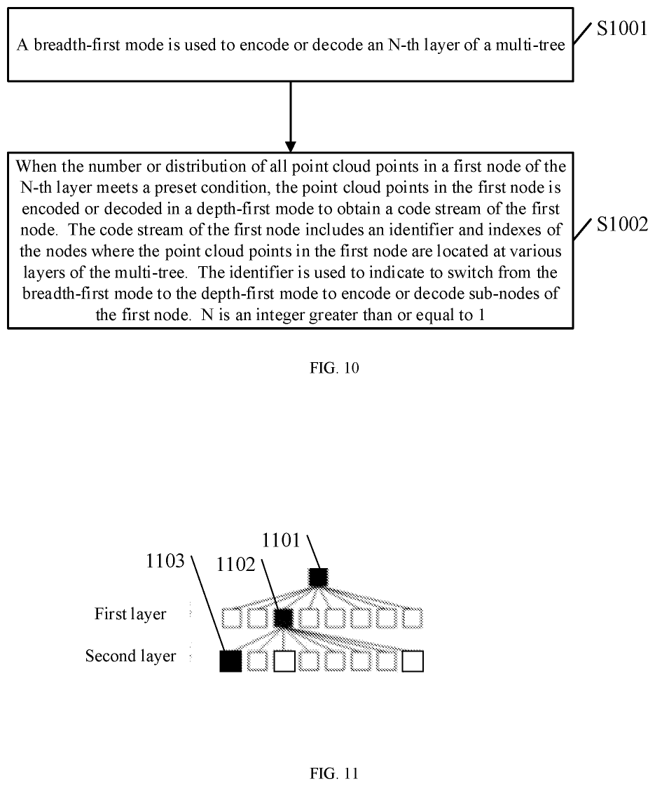

The present disclosure provides a point cloud processing method. The method may be applied to a point cloud processing device such as a point cloud encoding device or a point cloud decoding device as described above. In one embodiment, as shown in FIG. 10, the method includes S1001 and S1002.

In S1001, a breadth-first mode is used to encode or decode an N-th layer of a multi-tree.

In one embodiment, when the point cloud processing device encodes or decodes the point cloud, it may use a multi-tree division method to divide positions of the point cloud. When the point cloud processing device uses the multi-tree division method to divide the positions of the point cloud, the N-th layer of the multi-tree may be encoded or decoded in the breadth-first mode.

In some embodiments, the point cloud may be obtained by light detection (for example, laser detection) on an object to be detected by a light detection device. The light detection device may be, for example, a photoelectric radar, a lidar, a laser scanner, or any other equipment. The encoding device in the embodiment of the present disclosure may be integrated into the light detection device.

It should be noted that a lidar is a perceptual sensor that can obtain three-dimensional information of a scene. The basic principle of the lidar is to actively emit laser pulse signals to the object to be detected and obtain reflected pulse signals. According to a time difference between the transmitted signal and the received signal, the depth information of the distance between the object to be detected and the detector may be calculated. Also, angle information of the object to be detected relative to the lidar may be obtained according to the known transmission direction of the lidar. By combining the aforementioned depth information and angle information to a large number of detection points (called a point cloud) may be obtained.

In S1002, when the number or distribution of all point cloud points in a first node of the N-th layer meets a preset condition, the point cloud points in the first node are encoded or decoded in a depth-first mode to obtain a code stream of the first node. The code stream of the first node includes an identifier and indexes of the nodes where the point cloud points in the first node are located at various layers of the multi-tree. The identifier is used to indicate to switch from the breadth-first mode to the depth-first mode to encode or decode sub-nodes of the first node. That is, the encoding/decoding mode of the sub-nodes of the first node is switched from the breadth-first mode to the depth-first mode. N is an integer greater than or equal to 1. The first node is also referred to as a “target node.”

In one embodiment, when encoding or decoding the position coordinates of the point cloud, the encoding or decoding may be performed in a multi-tree manner. The multi-tree division may include any one or a combination of any two or three of: octree partition, quadtree partition, or binary tree partition. For example, the multitree division may include at least one of: octree division, octree quadtree division, octree binary-tree division, octree quadtree division, octree quadtree binary-tree division, quadtree division, binary tree division, quadtree octree division, binary-tree octree division, quadtree binary-tree octree division, binary-tree octree quadtree division, binary-tree octree quadtree division, binary-tree octree quadtree binary-tree division, binary-tree octree binary-tree division, quadtree octree division, quadtree octree quadtree division, quadtree octree binary-tree division, quadtree octree quadtree binary-tree division, quadtree binary-tree octree binary-tree division, quadtree binary-tree octree division, quadtree binary-tree octree quadtree division, quadtree binary-tree octree binary-tree division.

In one embodiment, the octree quadtree division may be using octree division and quadtree division to encode or decode the position coordinates of the point cloud. For example, the octree division is used for the first node and the quadtree division is used for one or more sub-nodes including point cloud points obtained by the octree division. In another embodiment, the octree binary-tree division may be using octree division and binary tree division to encode or decode the position coordinates of the point cloud. For example, the octree division is used for the first node and the binary-tree division is used for one or more sub-nodes including point cloud points obtained by the octree division. In another embodiment, the octree quadtree binary tree division may be using octree division, quadtree division, and binary tree division to encode or decode the position coordinates of the point cloud. For example, the octree division is used for the first node, the quadtree division is used for one or more sub-nodes including point cloud points obtained by the octree division, and the binary-tree division is used for one or more sub-nodes including point cloud points obtained by the quadtree division. In another example, the octree division is used for the first node, the binary-tree division is used for one or more sub-nodes including point cloud points obtained by the octree division, and the quadtree division is used for one or more sub-nodes including point cloud points obtained by the binary-tree division. In other embodiments, other division methods similar to the foregoing division methods may be used, and will not be repeated here.

In one embodiment, the N-th layer may be obtained by using the octree division, and the identifier may be eight bits of 0; or, the N-th layer may be obtained by using the quadtree division, and the identifier may be four bits of 0; or, the N-th layer may be obtained by using the binary tree division, and the identifier may be two bits of 0.

In one example, when switching, if the current position division is octree division, eight bits of 0, that is, 00000000, may be used as the identifier for switching from the breadth-first mode to the depth-first mode; if the current position division is quadtree division, four bits of 0, that is, 0000, may be used as the identifier for switching from the breadth-first method to the depth-first method; if the current position division is binary tree division, two bits of 0, that is, 00 may be used as the identifier for switching from the breadth-first method to the depth-first mode.

In some embodiments, the index may be represented by fixed 3 bits. In some embodiments, when the N-th layer is obtained by using the octree division, the index may be 0 to 7, which is represented by 3 bits, that is, 000-111 correspondingly; when the N-th layer is obtained by using the quadtree division, the index may be 0 to 3, which is represented by 2 bits, that is, 00-11, Correspondingly; when the N-th layer is obtained by the binary tree division, the index may be 0 to 1, which is represented by one bit, that is, 0-1, correspondingly.

In one embodiment, the encoding end may add indication information to the header information to indicate the division mode under the first node for which the encoding mode is switched to the depth-first mode. For example, the division mode may include division tree used for part of the layers below the first node. For example, the division mode includes that the first i layers under the first node are divided by a multi-tree. Or the indication information may be used to indicate that the index of how many bits are used to indicate the nodes containing the point cloud points in the first i layers below the first node for which the encoding mode is switched to the depth-first mode.

For example, the indication information is used to indicate that the first i layers are divided by the quadtree division below the first node for which the encoding mode is switched to the depth-first mode. Correspondingly, when the encoding end divides the positions of the first node, the first i layers are divided by quadtree division or quadtree and binary tree division. When encoding the node A in the (i+1)-th layer below the first node, the number of branches of the multi-tree to divide the node A is determined according to the side length of the node A, and the index with a corresponding number of bits is used to label sub-nodes B containing the point cloud points below the node A.

For example, whether the side length of the node A in the three directions of the x-axis, y-axis, and z-axis reaches the minimum side length are determined respectively. When the three directions do not reach the minimum side length, octree may be used to divide the node A and 3 bits may be used to identify the sub-node B that contains the point cloud points under the node A. When one direction reaches the minimum side length and other two directions do not reach the minimum side length, the quadtree may be used to divide the node A, and 2 bits may be used to identify the sub-node B that contains the point cloud points under the node A. When two directions reach the minimum side length, and one other direction does not reach the minimum side length, the binary tree may be used to divide the node A, and 1 bit may be used to identify the sub-node B that contains the point cloud points under the node A. When the node A reaches the minimum side length in all three directions, the division of the node A may be stopped.

At the decoding end, when the code stream of the first node decoded to the N-th layer contains the identifier, it may be determined to switch to the depth-first mode to decode the first node. The decoding end may determine the division mode of the first node according to the instruction information. For example, the division mode may include how many branches of multi-tree are used for dividing the first i layers of the first node. For example, when the instruction information indicates the first 2 layers of quadtree division of the first node, the first node may be divided by using a quadtree or a quadtree binary-tree. For the node A containing the point cloud points on the (i+1)-th layer of the first node, the number of the branches of the multi-tree for dividing the node A may be determined according to the side length of the node A, and the index with a corresponding number of bits may be used to label sub-nodes B containing the point cloud points below the node A.

For example, whether the side length of the node A in the three directions of the x-axis, y-axis, and z-axis reaches the minimum side length are determined respectively. When the three directions do not reach the minimum side length, octree may be used to divide the node A and 3 bits may be used to identify the sub-node B that contains the point cloud points under the node A. When one direction reaches the minimum side length and other two directions do not reach the minimum side length, the quadtree may be used to divide the node A, and 2 bits may be used to identify the sub-node B that contains the point cloud points under the node A. When two directions reach the minimum side length, and one other direction does not reach the minimum side length, the binary tree may be used to divide the node A, and 1 bit may be used to identify the sub-node B that contains the point cloud points under the node A. When the node A reaches the minimum side length in all three directions, the division of the node A may be stopped.

In one embodiment, the code stream of at least one layer below the N-th layer of the first node (i.e., the part of the code stream of the first node for the at least one layer below the N-th layer) may include the indexes of the sub-nodes of the first node that contains point cloud points in the at least one layer, as well as a first indicator bit. The first indicator bit may be used to indicate whether the at least one layer is the lowest layer of the first node. For example, when the first indicator bit is 0, it is determined that the at least one layer is the lowest layer of the first node; and when the first indicator bit is 1, it is determined that the at least one layer is not the lowest layer of the first node.

In one embodiment, the first indicator bit may be located before the indexes of all sub-nodes containing point cloud points in the at least one layer, or after the indexes of all sub-nodes containing point cloud points in the at least one layer.

For example, in the octree division shown in FIG. 11 which is a schematic flow chart of a point cloud encoding process provided by one embodiment of the present disclosure, a node 1101 obtained by the octree division includes point cloud points. The octree division is performed on the node 1101 to obtain the first layer where the third sub-node 1102 of the first layer contains point cloud points, and then the octree division is performed on the third sub-node 1102 of the first layer to obtain the second layer where the first sub-node 1103 of the second layer contains point cloud points. The second layer is the lowest layer.

For example, assuming that the first indicator bit is located after the indexes of all sub-nodes containing point cloud points in the layer and the indexes of the nodes of each layer are 0 to 7 from left to right, the index of the third sub-node 1102 of the first layer is determined to be 2 or 010, and the index of the first sub-node 1103 of the second layer is determined to be 0 or 000. Therefore, when encoding the node 1101 by octree division, the 8 bits of 0 of the identifier can be encoded first, that is, 00000000, which is used to indicate the switching from the breadth-first method to the depth-first method for encoding, and then the node 1101 is encoded.

Subsequently, the index 2 corresponding to the third sub-node 1102 of the first layer obtained by the octree division is encoded to obtain 010, and then one bit 1 of the first indicator bit is added to indicate that the first layer is not the lowest layer of the node 1101. And then the index 0 corresponding to the first sub-node 1103 in the second layer obtained by dividing the third sub-node 1102 of the first layer by the octree division is encoded to obtain 000, and the first indicator bit 0 is added to indicate the second layer is the lowest layer under the node 1101. Therefore, the code stream obtained by performing octree division encoding on the node 1101 in the depth-first mode is 0000000001010000.

In another example, assuming that the first indicator bit is located before the indexes of all sub-nodes containing the point cloud points in the layer and the indexes of the nodes of each layer are 0 to 7 from left to right, the index of the third sub-node 1102 of the first layer is determined to be 2 or 010, and the index of the first sub-node 1103 of the second layer is determined to be 0 or 000. Therefore, when encoding the node 1101 by octree division, 1 is encoded for the node 1101 and then the 8 bits of 0 of the identifier, that is, 00000000 is encoded to indicate the switching from the breadth-first method to the depth-first method for encoding. Subsequently, one bit 1 of the first indicator bit is added to determine that the first layer is not the lowest layer of the node 1101 and then the index 2 corresponding to the third sub-node 1102 of the first layer obtained by the octree division is encoded to obtain 010. And then the first indicator bit 0 is added to indicate the second layer is the lowest layer under the node 1101, and the index 0 corresponding to the first sub-node 1103 in the second layer obtained by dividing the third sub-node 1102 of the first layer by the octree division is encoded to obtain 000. Therefore, the code stream obtained by performing octree division encoding on the node 1101 in the depth-first mode is 10000000010100000.

For the decoding end, when the code stream to be decoded is obtained, it can perform arithmetic decoding first to decode the code stream related to the position information. When performing the octree decoding, the code stream of the position coordinates may be decoded in sequence. When the code stream is in the breadth-first mode, it may be decoded in the breadth-first order, and when the code stream is in the depth-first mode, it may be decoded in the depth-first order. Through octree decoding and inverse quantization, the reconstructed position coordinates may be obtained. When multi-tree decoding is performed on the code stream of the position coordinates, the decoding may be performed in the breadth-first order by default. When the decoding reaches the identifier used to indicate switching from the breadth-first mode to the depth-first mode (for example, 8 bits of 0, that is, 00000000), decoding and reconstruction may be performed with the decoding mode switched to the depth-first mode. The octree decoding of the position coordinates may be achieved by decoding in the above order.

In one embodiment, when decoding the code stream of at least one layer below the N-th layer in the first node, when the decoding reaches the identifier for indicating switching from the breadth-first mode to the depth-first mode (for example, decoding to 8 bits of 0, that is, 00000000), the index of the sub-nodes of the first node in the layer below the N-th layer that containing the point cloud point may be decoded subsequently, and then the first indicator bit indicating whether the layer is the lowest layer blow the first node may be decoded. When the first indicator bit indicates that the layer is not the lowest layer blow the first node, the index of the sub-nodes of the first node in the next layer of the layer below the N-th layer that contains the point cloud point may be decoded subsequently. When decoding to the first indicator bit indicating that the layer is the lowest layer blow the first node, it may be determined that the decoding is completed.

For example, as shown in FIG. 11, the code stream obtained by performing octree division and encoding on the node 1101 is 10000000001010000. Octree decoding is performed on the code stream of the node 1101, and when decoding to the identifier for indicating switching from the breadth-first mode to the depth-first mode, that is, 8 bits of 0 (00000000), the depth-first mode is used to decode 010 subsequently, to obtain the index 2 corresponding to the third sub-node 1102 of the first layer obtained by dividing the node 1101 with octree. Then, the first indicator bit 1 is decoded and 000 is decoded, to obtain the index 0 corresponding to the first sub-node 1103 of the second layer obtained by dividing the third sub-node 1102 of the first layer of the octree. When the first indicator bit is decoded to 0, it is determined that decoding of the code stream of the node 1101 is over.

In one embodiment, the number or distribution of all the point cloud points in the first node of the N-th layer may satisfy a preset condition, including: a number of the leaf nodes of the first node in the lowest layer below the N-th layer is smaller than or equal to 2; or, the number of all point cloud points of the first node is smaller than or equal to 2.

In one embodiment, the code stream of each layer below the N-th layer of the first node (i.e., the part of the code stream of the first node for each layer below the N-th layer) may include a second indicator bit. The second indicator bit may be used to indicate a number of nodes containing the point cloud points in the layer. Optionally, the present embodiment may be adopted when the following conditions are met: the number of leaf nodes at the lowest layer of the first node below the N-th layer is less than or equal to 2; or, the number of all point cloud points of the first node is smaller than or equal to 2 and the number of layers obtained by the multi-tree division of the first node is larger than n where n is greater than or equal to 2. In one embodiment, the second indicator bit may be used to indicate that the number of nodes containing point cloud points of the first node in the first layer is 1 or 2. For example, when the second indicator bit is 0, it is used to indicate that the number of nodes containing point cloud points in the layer is 1; when the second indicator bit is 1, it is used to indicate the number of nodes containing point cloud points in the layer is 2.

In one embodiment, the code stream of each layer below the N-th layer of the first node may include the indexes of all nodes containing point cloud points in the layer after the second indicator bit.

For example, as shown in FIG. 11, when encoding the node 1101 by octree division, the 8 bits of 0 of the identifier can be encoded first, that is, 00000000, which is used to indicate the switching from the breadth-first method to the depth-first method for encoding, and then the second indicator bit 0 is added for indicating that one node in the first layer contains the point cloud points. Subsequently, the index 2 corresponding to the third sub-node 1102 of the first layer obtained by the octree division is encoded to obtain 010, then the second indicator bit 0 is added for indicating that one node in the second layer contains the point cloud points. Subsequently, the index 0 corresponding to the first sub-node 1103 in the second layer obtained by dividing the third sub-node 1102 of the first layer by the octree division is encoded to obtain 000. Therefore, the code stream obtained by performing octree division encoding on the node 1101 in the depth-first mode is 0000000000100000.

For the decoding end, when decoding the code stream of each layer below the N-th layer in the first node, when decoding the identifier for indicating switching from the breadth-first mode to the depth-first mode (for example, decoding to 8 bits of 0, that is, 00000000), the second indicator bit for indicating the number of nodes containing the point cloud points in the layer may be decoded subsequently. Then the index of the sub-nodes of the first node in the current layer that contains the point cloud point may be decoded, and the second indicator bit for indicating the number of nodes containing the point cloud points in the next layer may be decoded subsequently. Then the index of the sub-nodes of the first node in the next layer that contains the point cloud point may be decoded. In this way, the second indicator bit of each layer below the N-th layer of the first node and the index of the sub-nodes containing the point cloud point may be decoded cyclically until decoding of the second indicator bit and the sub-nodes containing the point cloud points of each layer below the N-th layer in the first node is completed.

For example, as shown in FIG. 11, the code stream obtained by performing octree division and encoding on the node 1101 is 0000000000100000. Octree decoding is performed on the code stream of the node 1101, and when decoding to the identifier for indicating switching from the breadth-first mode to the depth-first mode, that is, 8 bits of 0 (00000000), the depth-first mode is used to decode the second indicator bit 0 for indicating the number of nodes containing the point cloud points in the current layer. It is determined the first layer includes one sub-nodes containing the point cloud points. Then 010 is decoded subsequently to obtain the index 2 corresponding to the sub-node containing the point cloud points in the first layer, that is, to determine that the sub-node containing the point cloud points in the first layer is the third sub-node 1102 of the first layer. Then, the second indicator bit 0 for indicating the number of nodes containing the point cloud points in the second layer is decoded, to determine that the second layer includes one sub-nodes containing the point cloud points. Subsequently, 000 is decoded, to obtain the index 0 corresponding to the sub-node containing the point cloud points in the second layer, that is, to determine that the sub-node containing the point cloud points in the second layer is the first sub-node 1103 of the second layer.

In one embodiment, when the number of leaf nodes at the lowest layer of the first node below the N-th layer is less than or equal to 2; or, when the number of all point cloud points in the first node is less than or equal to 2 and the number of layers obtained by the multi-tree division of the first node is greater than n where n is greater than or equal to 2, the code stream of the first node may include a third indicator bit, and the third indicator bit may be used for indicating the number of leaf nodes containing the point cloud points below the N-th layer of the first node. In one embodiment, the third indicator bit may be used to indicate that the number of leaf nodes containing the point cloud points below the N-th layer of the first node is 1 or 2. In one embodiment, the third indicator bit may be 0, which is used to indicate that the number of leaf nodes containing the point cloud points below the N-th layer of the first node is 1. The third indicator bit may be 1, to indicate that the number of leaf nodes containing the point cloud points below the N-th layer of the first node is 2.

In one embodiment, the code stream of the first node may further include the indexes of all nodes of the first node containing point cloud points below the N-th layer.

For example, as shown in FIG. 11, when encoding the node 1101 by octree division, the 8 bits of 0 of the identifier can be encoded first, that is, 00000000, which is used to indicate the switching from the breadth-first method to the depth-first method for encoding. Subsequently, the third indicator bit 0 is added when the number of leaf nodes containing the point cloud points obtained by performing octree division and encoding on the node 1101 is 1. Subsequently, the index 2 corresponding to the third sub-node 1102 of the first layer obtained by the octree division is encoded to obtain 010. Then, the index 0 corresponding to the first sub-node 1103 in the second layer obtained by dividing the third sub-node 1102 of the first layer by the octree division is encoded to obtain 000. Therefore, the code stream obtained by performing octree division encoding on the node 1101 in the depth-first mode is 000000000010000.

For the decoding end, when decoding the code stream of each layer below the N-th layer in the first node, when decoding the identifier for indicating switching from the breadth-first mode to the depth-first mode (for example, decoding to 8 bits of 0, that is, 00000000), the third indicator bit indicating the number of leaf nodes of the first node containing the point cloud points below the N-th layer may be decoded subsequently. Then the index of the sub-nodes of the first node in the current layer that contains the point cloud point may be decoded, and the index of the sub-nodes of the first node in the next layer that containing the point cloud point may be decoded, until decoding of the second indicator bit and the sub-nodes containing the point cloud points of each layer below the N-th layer in the first node is completed.

For example, as shown in FIG. 11, the code stream obtained by performing octree division and encoding on the node 1101 is 000000000010000. Octree decoding is performed on the code stream of the node 1101. When decoding to the identifier for indicating switching from the breadth-first mode to the depth-first mode, that is, 8 bits of 0 (00000000), the depth-first mode is used to decode the third indicator bit 0 which indicates the number of leaf nodes of the node 1101 containing the point cloud points in the first layer. That is, the number of leaf nodes of the node 1101 containing the point cloud points in the first layer is determined to be 1. Then 010 is decoded subsequently to obtain the index 2 corresponding to the sub-node containing the point cloud points in the first layer, that is, to determine that the sub-node containing the point cloud points in the first layer is the third sub-node 1102 of the first layer. Then, 000 is decoded, to obtain the index 0 corresponding to the sub-node containing the point cloud points in the second layer, that is, to determine that the sub-node containing the point cloud points in the second layer is the first sub-node 1103 of the second layer.

In one embodiment, the number or distribution of all point cloud points in the first node of the N-th layer satisfies a preset condition, may include: that the distribution of specific nodes of the first node in at least M consecutive layers below the N-th layer is same. The specific nodes may be nodes containing point cloud points, and the M may be a preset positive integer.

In one embodiment, that the distribution of specific nodes of the first node in at least M consecutive layers below the N-th layer is same may mean that the indexes of the sub-nodes containing the point cloud points in each layer of the at least M consecutive layers below the N-th layer of the first node are same. In one example, assuming that M is 2, if the sub-nodes containing the point cloud points in each layer of two consecutive layers below the N-th layer of the first node are located in the third sub-node and the eighth sub-node in each layer of the two consecutive layers, it may be determined that the distribution of specific nodes of the first node in the two consecutive layers below the N-th layer is same.

In one embodiment, the code stream of the first node may include the number of layers with the same distribution of the specific nodes below the N-th layer of the first node, and the indexes of the specific nodes.

In one embodiment, the number of layers with the same distribution of the specific nodes may be obtained by encoding using a fixed-length encoding method or a variable-length encoding method.

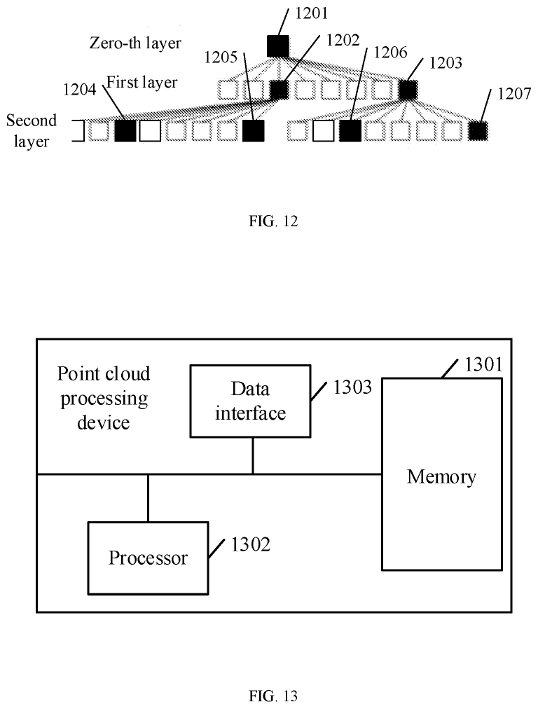

FIG. 12 is a schematic diagram showing another point cloud encoding process provided by one embodiment of the present disclosure. For example, as shown in FIG. 12, assuming that the node 1201 at the 0th layer obtained by octree division includes point cloud points, the octree division is performed on the node 1201 to obtain the third sub-node 1202 of the first layer containing the point cloud points and the eighth sub-node 1203 containing the point cloud points. And then, the octree division is performed on the third sub-node 1102 of the first layer to obtain the third sub-node 1204 of the second layer containing the point cloud points and the eighth sub-node 1205 containing the point cloud points. Subsequently, the octree division is performed on the eighth sub-node 1203 of the first layer to obtain the third sub-node 1206 and the eighth sub-node 1207 of the second layer. The second layer is the bottom layer.

For example, the index of the nodes of each layer is 0 to 7 from left to right. The point cloud point distribution of the node 1201 in two consecutive layers including the first layer and the second layer is the same. That is, the third sub-node and the eighth sub-node in the first layer of the node 1201 contain the point cloud points, the third sub-node and the eighth sub-node in the second layer of the third sub-node in the first layer contain the point cloud points, and the third sub-node and the eighth sub-node in the second layer of the eighth sub-node in the first layer contain the point cloud points. Therefore, when encoding the node 1201 by octree division, 8 bits of 0 of the identifier, that is, 00000000, is first encoded to indicate the switching from the breadth-first mode to the depth-first mode for encoding. And then, 3-bit index of the number of layers with the same point cloud distribution, that is, 000-111, is encoded. Here, encoding 3-bit index of the number of layers with the same point cloud distribution is encoding the index 2−1=1 to obtain 001. After encoding the index of the number of layers with the same point cloud distribution, when the leaf node is reached, the encoding is completed; when the leaf node is not reached, the octree division is continued. In the present example, after encoding the layer index 001, the leaf node has not been reached. Correspondingly, the index 2 corresponding to the third sub-node 1202 of the first layer obtained by the octree division of the node 1201 is encoded to obtain 010, the index 7 corresponding to the eighth sub-node 1203 of the first layer is encoded to obtain 111, the index 2 corresponding to the third sub-node 1204 in the second layer obtained by performing the octree division on the third sub-node 1202 in the first layer is encoded to obtain 010, and the index 7 corresponding to the eighth sub-node 1205 in the second layer obtained by performing the octree division on the third sub-node 1202 in the first layer is encoded to obtain 111, the index 2 corresponding to the third sub-node 1206 in the second layer obtained by performing the octree division on the eighth sub-node 1203 in the first layer is encoded to obtain 010, and the index 7 corresponding to the eighth sub-node 1207 in the second layer obtained by performing the octree division on the eighth sub-node 1203 in the first layer is encoded to obtain 111. Therefore, the code stream obtained by performing octree partitioning and encoding on the node 1101 in a depth-first manner is 00000000001010111010111010111.

For the decoding end, in one embodiment, when decoding the code stream of each layer below the N-th layer in the first node, when decoding to the identifier for indicating switching from the breadth-first mode to the depth-first mode (for example, decoding to 8 bits of 0, that is, 00000000), the number of layers with the specific nodes with the same point cloud distribution of the first node below the N-th layer may be decoded subsequently. Then the indexes of the specific nodes in each layer below the N-th layer of the first node may be decoded.

For example, as shown in FIG. 12, the code stream obtained by performing octree division and encoding on the node 1201 is 00000000 001010111010111010111. Octree decoding is performed on the code stream of the node 1201. When decoding to the identifier for indicating switching from the breadth-first mode to the depth-first mode, that is, 8 bits of 0 (00000000), the depth-first mode is used to decode 001 subsequently, to obtain that the index of the number of layers with the same point cloud distribution of the node 1201 below the zeroth layer is 1+1=2 (that is, the first layer and the second layer). 010 and 111 are decoded then to obtain that the indexes of the sub-nodes containing the point cloud points of the node 1201 in the first layer are 2 and 7, that is, to determine that the sub-nodes containing the point cloud points of the node 1201 in the first layer are the sub-node 1202 and the sub-node 1203. 010 and 111 are decoded then to obtain that the indexes of the sub-nodes containing the point cloud points of the sub-node 1202 in the second layer are 2 and 7, that is, to determine that the sub-nodes containing the point cloud points of the sub-node 1202 in the second layer are the sub-node 1204 and the sub-node 1205. 010 and 111 are decoded then to obtain that the indexes of the sub-nodes containing the point cloud points of the sub-node 1203 in the second layer are 2 and 7, that is, to determine that the sub-nodes containing the point cloud points of the sub-node 1203 in the second layer are the sub-node 1206 and the sub-node 1207.

In one embodiment, after the index of each leaf node, the code stream of the first node may further include the number of the point cloud points contained in the leaf node.

In one embodiment, when encoding the number of point cloud points contained in a leaf node, when the current leaf node contains a point cloud point, a 0 can be directly encoded to indicate that; and when the current leaf node contains more than one point cloud point, assuming that there are n point cloud points in the current leaf node, a 1 will be encoded first, and then the value (n−1) will be encoded.

For example, as shown in FIG. 11, the code stream of the node 1101 obtained after the octree division of the node 1101 is 0000000001010000. When the number of point cloud points included in the first sub-node 1103 (that is, the leaf node) of the second layer obtained after the octree division of the node 1101 is 1, in the code stream of the node 1101, after the index of the leaf node 1103, the number 1 of the point cloud points contained in the leaf node 1103 is encoded to obtain 0. Therefore, the obtained code stream of node 1101 is 00000000010100000.

It can be seen that by encoding or decoding the index of the sub-node of the first node in each layer below the N-th layer including the point cloud points in a depth-first mode, it is possible to avoid encoding or decoding each sub-node of the first node in the multi-tree division, therefore reducing the complexity of encoding or decoding and the time overhead. The parallel processing of encoding or decoding of point cloud compression may be improved, improving the encoding or decoding efficiency and performance.

In various embodiments, a plurality of encoding methods may be used when encoding the index of each sub-node of the first node that includes the point cloud point.

In one embodiment, the encoding methods may be determined according to the side length of the current sub-node obtained by the octree division of the first node. Each sub-node is a sub block of the cube obtained by dividing. Assuming that the side length of the current sub-node is 2ⁿ, only the low n bits of the corresponding position coordinates of the current point cloud point may need to be encoded at this time.

In one embodiment, a plurality of encoding methods may be used when encoding the low n bits of the position coordinates. For example, in one embodiment, n bits corresponding to the three directions of x, y, and z, that is, n bits x, n bits y, and n bits z, can be consecutively coded where the sequence is not limited. In another embodiment, x, y, z may be encoded from the high bit. That is, the n-th bit from the low bit of x may be encoded first, then the n-th bit from the low bit of y may be encoded, and then the n-th bit of z from the low bit may be encoded, until the encoding reaches the lowest bit. The sequence of x, y, z is not limited, and the sequence of each bit is not limited, as long as the sequence is consistent with the encoding and decoding. In another embodiment, x, y, z may be encoded from the lowest bits. That is, the 0-th bit from the low bit of x may be encoded first, then the 0-th bit from the low bit of y may be encoded, and then the 0-th bit of z from the low bit may be encoded. The sequence of x, y, z is not limited, and the sequence of each bit is not limited, as long as the sequence is consistent with the encoding and decoding. In another embodiment, it may be not fixed which bit to start encoding, as long as bits corresponding to the three directions of x, y, and z are encoded finally. The embodiments of the present disclosure do not specifically limit the encoding mode for encoding the index of each sub-node.

In one example, when encoding the index, a bypass encoding method may be used to encode the bits in different directions in the index, that is, the entropy encoding may be performed on the bits in the index used to indicate different directions using an equal probability model.

For example, when encoding or decoding the index, different probability models may be used to perform entropy encoding or decoding on the bits used to indicate different directions in the index, respectively. For example, when the index uses 3 bits, the first bit of all indexes is entropy-encoded using the first context model, and the first context model is updated according to the encoding result. The second bit of all indexes is entropy-encoded using the second context model, and the second context model is updated according to the encoding result. The third bit of all indexes is entropy-encoded using the third context model, and the third context model is updated according to the encoding result.

In one example, the code stream of the point cloud may be also provided with an identification bit in the header information which is used to indicate whether to enable the switch to the depth-first mode for position encoding or decoding. The header information may be geometric header information or sequence header information. When the decoding end parses the identification bit from the code stream of the point cloud, it may determine whether to enable switching to the depth-first mode for position decoding according to the identification bit. When the identifier indicates that it is enabled to switch to the depth-first mode for position decoding, if the identification bit is parsed from the code stream of the first node, it can be determined to switch to the depth-first mode to perform position decoding on the code stream of the first node.

In the present disclosure, the point cloud processing device may encode or decode the N-th layer of the multi-tree in the breadth-first mode. When the number or distribution of all point cloud points in the first node of the N-th layer meets the preset conditions, the point cloud in the first node may be encoded or decoded in the depth-first mode to obtain the code stream of the first node. The code stream of the first node may include the identifier and the indexes of nodes in each layer of the multi-tree containing the point cloud points in the first node. The identifier may be used to indicate that the sub-nodes of the first node are encoded or decoded with the encoding or decoding mode switched from the breadth-first mode to the depth-first mode. N may be an integer greater than or equal to 1. Through this implementation manner, encoding or decoding of each sub-node of the first node in the multi-tree division may be avoided. The complexity of encoding or decoding and the time overhead may be reduced, therefore improving the parallel processing of encoding or decoding of the point cloud compression. The efficiency and performance of encoding or decoding may be improved.

For the convenience of description, the side lengths of the first node of the N-th layer in the three directions are assumed to be the a-th power of 2, the b-th power of 2, and the c-th power of 2, and the minimum side length of the node of the point cloud is the d-th power of 2. Among them, the minimum side length may be that when the point cloud is divided into a multi-tree, when the side length of a node in one direction is less than or equal to the minimum side length, the division in that direction is stopped. Optionally, the minimum side length may be 1. a, b, c, and d are integers. It is understandable that when the initialization space of the point cloud is a cube and the cube is divided by an octree, a=b=c; and when the initialization space of the point cloud is another shape (such as a rectangular parallelepiped), or the initialization space is a cube but a mixture of multiple tree divisions (for example, octree first and quadtree) is used, the three values of a, b, and c may not be equal.

In one example, that the number or distribution of all point cloud points in the first node of the N-th layer satisfies a preset condition, may include: the number of leaf nodes containing the point cloud points below the first node is less than or equal to 2, and the sum of (a−d)+(b−d)+(c-d) of the first node is greater than or equal to 2 multiples of e, where e is the number of the three numbers a, b, and c whose value is not equal to d. For example, if a=d in the first node, but b and c are not equal to d, the value of e is 2. In another example, a and b of the first node are both equal to d, but c is not equal to d, the value of e is 1. For example, when the number of leaf nodes containing the point cloud points in the first node is 1, and the sum of (a−d)+(b−d)+(c−d) of the first node is greater than or equal to 2 multiples of e, the point cloud in the first node is encoded or decoded in the depth-first mode.

In one example, when performing position encoding on the point cloud, the positions of the point cloud may be encoded with the encoding mode switched from the breadth-first mode to the depth-first mode; or, directly the depth-first mode or starting from the depth-first mode may be used to encode the positions of the point cloud. In any encoding method, N bits of 0 may be used in the code stream as an identifier to indicate that the next code stream is encoded in the depth-first mode. For example, when the current node is divided into an octree, 8 bits of 0 can be used as an identifier to indicate that the code stream of the current node is encoded in the depth-first mode. For another example, when the current node is divided into a quadtree, 4-bit 0 may be used as an identifier to indicate that the code stream of the current node is encoded in the depth-first mode. For another example, when the current node is divided into a binary tree, 2-bit 0 can be used as an identifier to indicate that the code stream of the current node is encoded in the depth-first mode.

The present disclosure also provides a point cloud processing device. In one embodiment shown in FIG. 13, the point cloud processing device includes a memory 1301, a processor 1302, and a data interface 1303.

The memory 1301 may include a volatile memory. The memory 1301 may also include a non-volatile memory. The memory 1301 may also include a combination of a volatile memory or a non-volatile memory. The processor 1302 may be a central processing unit (CPU). The processor 1302 may further include a hardware point cloud processing device. The hardware point cloud processing device may be an application-specific integrated circuit (ASIC), a programmable logic device (PLD), or a combination thereof. For example, it may be a complex programmable logic device (CPLD), a field-programmable gate array (FPGA), or any combination thereof.

The memory 1301 may be configured to store programs that could be executed in the processor.

The processor 1302 may be configured to execute the programs stored in the memory to:

use a breadth-first mode to encode or decode an N-th layer of a multi-tree; and

when a number or distribution of all point cloud points in a first node of the N-th layer meets a preset condition, use a depth-first mode to encode or decode the point cloud points in the first node to obtain a code stream of the first node.

The code stream of the first node may include an identifier and indexes of the point cloud points in the first node at each layer of the multi-tree. The identifier may be used to indicate that sub-nodes of the first node are encoded or decoded with the encoding or decoding mode switched from the breadth-first mode to the depth-first mode. N may be an integer greater than or equal to 1.

Optionally, the code stream of at least one layer below the N-th layer of the first node may include the indexes of the sub-nodes of the first node that contains point cloud points in the at least one layer, and a first indicator bit. The first indicator bit may be used to indicate whether the at least one layer is the lowest layer of the first node.

Optionally, the first indicator bit may be located before the indexes of all sub-nodes containing point cloud points in the at least one layer, or after the indexes of all sub-nodes containing point cloud points in the at least one layer.

Optionally, the code stream of each layer below the N-th layer of the first node may include a second indicator bit. The second indicator bit may be used to indicate a number of nodes containing the point cloud points in the layer.

Optionally, the second indicator bit may be used to indicate that the number of nodes containing point cloud points of the first node in the first layer is 1 or 2.

Optionally, the code stream of each layer below the N-th layer of the first node may include the indexes of all nodes containing point cloud points in the layer after the second indicator bit.

Optionally, the code stream of the first node may include a third indicator bit, and the third indicator bit may be used for indicating the number of leaf nodes containing the point cloud points below the N-th layer of the first node.

Optionally, the third indicator bit may be used to indicate that the number of leaf nodes containing the point cloud points below the N-th layer of the first node is 1 or 2.

Optionally, the code stream of the first node may further include the indexes of all nodes of the first node containing point cloud points below the N-th layer.

Optionally, the number or distribution of all point cloud points in the first node of the N-th layer satisfies a preset condition, may include: a number of leaf nodes in the lowest layer of the first node below the N-th layer is smaller than or equal to 2; or the number of all point cloud points of the first node is smaller than or equal to 2.

Optionally, the number or distribution of all point cloud points in the first node of the N-th layer satisfies a preset condition, may include: that the distribution of specific nodes of the first node in at least M consecutive layers below the N-th layer is same. The specific nodes may be nodes containing point cloud points, and the M may be a preset positive integer.

Optionally, the code stream of the first node may include the number of layers with the same distribution of the specific nodes below the N-th layer of the first node, and the indexes of the specific nodes.

Optionally, after the index of each leaf node, the code stream of the first node may further include the number of the point cloud points contained in the leaf node.

Optionally, the number of layers with the same distribution of the specific nodes may be obtained by encoding using a fixed-length encoding method or a variable-length encoding method.

Optionally, the multi-tree division may include any one of, any combination of two of, or any combination of three of: octree division, quadtree division, or binary tree division.

Optionally, the N-th layer may be obtained by the octree division and the identifier may be 8 bits of 0; or the N-th layer may be obtained by the quadtree division and the identifier may be 4 bits of 0; or the N-th layer may be obtained by the binary tree division and the identifier may be 2 bits of 0.

Optionally, the code stream of the point cloud may further include an identification bit which is used to indicate whether to enable the switch to the depth-first mode for position encoding or decoding.

In the present disclosure, the point cloud processing device may encode or decode the N-th layer of the multi-tree in the breadth-first mode. When the number or distribution of all point cloud points in the first node of the N-th layer meets the preset conditions, the point cloud in the first node may be encoded or decoded in the depth-first mode to obtain the code stream of the first node. The code stream of the first node may include the identifier and the indexes of nodes in each layer of the multi-tree containing the point cloud points in the first node. The identifier may be used to indicate that the sub-nodes of the first node are encoded or decoded with the encoding or decoding mode switched from the breadth-first mode to the depth-first mode. N may be an integer greater than or equal to 1. Through this implementation manner, encoding or decoding of each sub-node of the first node in the multi-tree division may be avoided. The complexity of encoding or decoding and the time overhead may be reduced, therefore improving the parallel processing of encoding or decoding of the point cloud compression. The efficiency and performance of encoding or decoding may be improved.

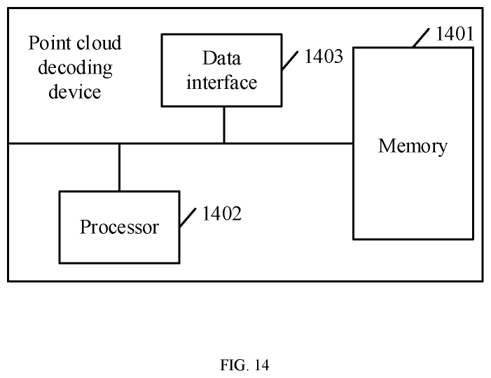

The present disclosure also provides a point cloud decoding device. In one embodiment shown in FIG. 14, the point cloud decoding device includes a memory 1401, a processor 1402, and a data interface 1403.

The memory 1401 may include a volatile memory. The memory 1401 may also include a non-volatile memory. The memory 1401 may also include a combination of a volatile memory or a non-volatile memory. The processor 1402 may be a central processing unit (CPU). The processor 1402 may further include a hardware point cloud processing device. The hardware point cloud processing device may be an application-specific integrated circuit (ASIC), a programmable logic device (PLD), or a combination thereof. For example, it may be a complex programmable logic device (CPLD), a field-programmable gate array (FPGA), or any combination thereof.

The memory 1401 may be configured to store programs that could be executed in the processor.

The processor 1402 may be configured to execute the programs stored in the memory to:

use a breadth-first mode to decode an N-th layer of a multi-tree; and

when parsing to an identifier, use a depth-first mode to decode a code stream of a first node of the N-th layer.

The code stream of the first node may include the identifier and indexes of the point cloud points in the first node at each layer of the multi-tree. The identifier may be used to indicate that sub-nodes of the first node are decoded with the decoding mode switched from the breadth-first mode to the depth-first mode. N may be an integer greater than or equal to 1.

Optionally, the code stream of at least one layer below the N-th layer of the first node may include the indexes of the sub-nodes of the first node that contains point cloud points in the at least one layer, and a first indicator bit. The first indicator bit may be used to indicate whether the at least one layer is the lowest layer of the first node.

Optionally, the first indicator bit may be located before the indexes of all sub-nodes containing point cloud points in the at least one layer, or after the indexes of all sub-nodes containing point cloud points in the at least one layer.

Optionally, the code stream of each layer below the N-th layer of the first node may include a second indicator bit. The second indicator bit may be used to indicate a number of nodes containing the point cloud points in the layer.

Optionally, the second indicator bit may be used to indicate that the number of nodes containing point cloud points of the first node in the first layer is 1 or 2.

Optionally, the code stream of each layer below the N-th layer of the first node may include the indexes of all nodes containing point cloud points in the layer after the second indicator bit.

Optionally, the code stream of the first node may include a third indicator bit, and the third indicator bit may be used for indicating the number of leaf nodes containing the point cloud points below the N-th layer of the first node.

Optionally, the third indicator bit may be used to indicate that the number of leaf nodes containing the point cloud points below the N-th layer of the first node is 1 or 2.

Optionally, the code stream of the first node may further include the indexes of all nodes of the first node containing point cloud points below the N-th layer.

Optionally, the number or distribution of all point cloud points in the first node of the N-th layer satisfies a preset condition, may include: a number of leaf nodes in the lowest layer of the first node below the N-th layer is smaller than or equal to 2; or the number of all point cloud points of the first node is smaller than or equal to 2.

Optionally, the number or distribution of all point cloud points in the first node of the N-th layer satisfies a preset condition, may include: that the distribution of specific nodes of the first node in at least M consecutive layers below the N-th layer is same. The specific nodes may be nodes containing point cloud points, and the M may be a preset positive integer.

Optionally, the code stream of the first node may include the number of layers with the same distribution of the specific nodes below the N-th layer of the first node, and the indexes of the specific nodes.

Optionally, after the index of each leaf node, the code stream of the first node may further include the number of the point cloud points contained in the leaf node.

Optionally, the number of layers with the same distribution of the specific nodes may be obtained by encoding using a fixed-length encoding method or a variable-length encoding method.

Optionally, the multi-tree division may include any one of, any combination of two of, or any combination of three of: octree division, quadtree division, or binary tree division.

Optionally, the N-th layer may be obtained by the octree division and the identifier may be 8 bits of 0; or the N-th layer may be obtained by the quadtree division and the identifier may be 4 bits of 0; or the N-th layer may be obtained by the binary tree division and the identifier may be 2 bits of 0.

Optionally, the code stream of the point cloud may further include an identification bit which is used to indicate whether to enable the switch to the depth-first mode for position encoding or decoding.

In the present disclosure, the point cloud processing device may encode or decode the N-th layer of the multi-tree in the breadth-first mode. When the number or distribution of all point cloud points in the first node of the N-th layer meets the preset conditions, the point cloud in the first node may be encoded or decoded in the depth-first mode to obtain the code stream of the first node. The code stream of the first node may include the identifier and the indexes of nodes in each layer of the multi-tree containing the point cloud points in the first node. The identifier may be used to indicate that the sub-nodes of the first node are encoded or decoded by switching from the breadth-first mode to the depth-first mode. N may be an integer greater than or equal to 1. Through this implementation manner, encoding or decoding of each sub-node of the first node in the multi-tree division may be avoided. The complexity of encoding or decoding and the time overhead may be reduced, therefore improving the parallel processing of encoding or decoding of the point cloud compression. The efficiency and performance of encoding or decoding may be improved.

The present disclosure also provides a computer-readable storage medium. The computer-readable storage medium may be configured to store a computer program. When the computer program is executed by a processor, the point cloud processing method provided by various embodiments of the present disclosure shown in FIG. 10, or the point cloud processing device provided by various embodiments of the present disclosure shown in FIG. 13, or the point cloud decoding device provided by various embodiments of the present disclosure shown in FIG. 14 may be implemented, which will not be repeated here.

The computer-readable storage medium may be an internal storage unit of the device described in any of the foregoing embodiments of the present disclosure, such as a hard disk or a memory of the device. The computer-readable storage medium may also be an external storage device of the device, such as a plug-in hard disk equipped on the device, a smart memory card (SMC), a secure digital card (SD), or a flash card, etc. Further, the computer-readable storage medium may also include both an internal storage unit of the device and an external storage device. The computer-readable storage medium may be used to store the computer program and other programs and data required by the device. The computer-readable storage medium may also be used to temporarily store data that has been output or will be output.

A person of ordinary skill in the art can be aware that the units and algorithm steps described in the embodiments disclosed herein can be implemented by electronic hardware, computer software, or a combination of both. To clearly illustrate the hardware and software interchangeability, in the above description, the composition and steps of each example have been generally described in accordance with the function. Whether these functions are executed by hardware or software depends on the specific application and design constraint conditions of the technical solution. Professionals and technicians can use different methods for each specific application to implement the described functions, but such implementation should not be considered beyond the scope of the present disclosure

Those skilled in the art can clearly understand that, for the convenience and conciseness of description, the specific working processes of the above-described system, device, and unit is not repeated, and reference can be made to the corresponding processes described in the foregoing method embodiments.

In the embodiments provided in the present disclosure, it should be understood that the disclosed system, device, and method may be implemented in other ways. For example, the device embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

When the integrated unit is implemented in the form of a software functional unit and sold or used as an independent product, it can be stored in a computer readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a U disk, a mobile hard disk, a read-only memory (ROM), a random access memory (RAM), a magnetic disk, an optical disk, or another medium that can store program codes.

The above are only specific implementations of embodiments of the present disclosure, but the scope of the present disclosure is not limited to this. Anyone familiar with the technical field can easily think of various equivalents within the technical scope disclosed in the present disclosure. These modifications or replacements shall be covered within the scope of the present disclosure. Therefore, the protection scope of the present disclosure shall be subject to the protection scope of the claims.

What is claimed is:

1. A processing method comprising:
encoding or decoding an N-th layer of a multi-tree using a breadth-first mode, the multi-tree being used for position division on a point cloud; and
in response to a number or a distribution of all point cloud points in a target node of the N-th layer meeting a preset condition, encoding or decoding the point cloud points in the target node using a depth-first mode to obtain a code stream of the target node;
wherein:
the code stream of the target node includes:
an identifier indicating to switch from the breadth-first mode to the depth-first mode to encode or decode sub-nodes of the target node; and
indexes of nodes where the point cloud points of the target node are located at various layers of the multi-tree; and
N is an integer greater than or equal to 1.

2. The method according to claim 1, wherein:
a part of the code stream of the target node for one layer below the N-th layer includes the index of a sub-node of the target node that contains point cloud points in the one layer, and an indicator bit; and
the indicator bit indicates whether the one layer is a lowest layer below the target node.

3. The method according to claim 2, wherein the indicator bit is located before or after the indexes of all sub-nodes containing point cloud points in the one layer.

4. The method according to claim 1, wherein a part of the code stream of the target node for one layer below the N-th layer includes an indicator bit indicating a number of nodes containing point cloud points in the one layer.

5. The method according to claim 4, wherein the indicator bit indicating that the number of nodes containing point cloud points in the one layer is 1 or 2.

6. The method according to claim 5, wherein the part of the code stream of the target node for the one layer below the N-th layer further includes, after the indicator bit, the indexes of all nodes containing point cloud points in the one layer.

7. The method according to claim 1, wherein the code stream of the target node includes an indicator bit indicating a number of leaf nodes of the target node below the N-th layer that contain point cloud points.

8. The method according to claim 7, wherein:
the indicator bit indicates that the number of leaf nodes containing point cloud points is 1 or 2.

9. The method according to claim 7, wherein the code stream of the target node further includes the indexes of all nodes of the target node below the N-th layer that contain point cloud points.

10. The method according to claim 1, wherein the number or the distribution of all point cloud points in the target node meeting the preset condition includes:
a number of leaf nodes of the target node in a lowest layer below the N-th layer is smaller than or equal to 2; or
a number of all point cloud points of the target node is smaller than or equal to 2.

11. A decoding method comprising:
decoding an N-th layer of a multi-tree using a breadth-first mode, the multi-tree being used for position division on a point cloud; and
in response to parsing to an identifier, decoding a code stream of a target node of the N-th layer using a depth-first mode;
wherein:
the code stream of the target node includes:
an identifier indicating to switch from the breadth-first mode to the depth-first mode to decode sub-nodes of the target node; and
indexes of nodes where the point cloud points of the target node are located at various layers of the multi-tree; and
N is an integer greater than or equal to 1.

12. The method according to claim 11, wherein:
a part of the code stream of the target node for one layer below the N-th layer includes the index of a sub-node of the target node that contains point cloud points in the one layer, and an indicator bit; and
the indicator bit indicates whether the one layer is a lowest layer below the target node.

13. The method according to claim 12, wherein the indicator bit is located before or after the indexes of all sub-nodes containing point cloud points in the one layer.

14. The method according to claim 11, wherein a part of the code stream of the target node for one layer below the N-th layer includes an indicator bit indicating a number of nodes containing point cloud points in the one layer.

15. The method according to claim 14, wherein the indicator bit indicating that the number of nodes containing point cloud points in the one layer is 1 or 2.

16. The method according to claim 15, wherein the part of the code stream of the target node for the one layer below the N-th layer further includes, after the indicator bit, the indexes of all nodes containing point cloud points in the one layer.

17. The method according to claim 11, wherein the code stream of the target node includes an indicator bit indicating a number of leaf nodes of the target node below the N-th layer that contain point cloud points.

18. The method according to claim 17, wherein:
the indicator bit indicates that the number of leaf nodes containing point cloud points is 1 or 2.

19. The method according to claim 17, wherein the code stream of the target node further includes the indexes of all nodes of the target node below the N-th layer that contain point cloud points.

20. A point cloud processing device comprising:
a memory storing a program; and
a processor configured to execute the program stored in the memory to:
encoding or decoding an N-th layer of a multi-tree using a breadth-first mode, the multi-tree being used for position division on a point cloud; and
in response to a number or a distribution of all point cloud points in a target node of the N-th layer meets a preset condition, encoding or decoding the point cloud points in the target node using a depth-first mode to obtain a code stream of the target node;
wherein:
the code stream of the target node includes:
an identifier indicating to switch from the breadth-first mode to the depth-first mode to encode or decode sub-nodes of the target node; and
indexes of nodes where the point cloud points of the target node are located at various layers of the multi-tree; and
N is an integer greater than or equal to 1.
